(19) United States
(12) Patent Application Publication
(10) Pub. No.: US 2008/0174998 A1
(43) Pub. Date: Jul. 24, 2008

(54) Emergency lamp having energy-saving effect

(76) Inventor: Hung - Shen Chang, Taoyuan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/657,293

(22) Filed: Jan. 24, 2007

(51) Int. Cl. F21S 9/03; F21S 9/02

(52) U.S. Cl. 362/240

(57) ABSTRACT

An emergency lamp includes a base, a lamp shade combined with the base, a control circuit mounted in the base, at least one storage battery mounted in the base, a light gathering board mounted in the lamp shade, a plurality of light emitting members mounted on the light gathering board, a light permeable board mounted on the lamp shade, and an optical energy board mounted on the lamp shade. Thus, the electric power of the emergency lamp is supplied by the optical energy board without needing an external electric power supply, so that the emergency lamp has an energy-saving effect. In addition, the emergency lamp has energy-saving, emergency illuminating and emergency direction indicating functions, thereby enhancing the versatility of the emergency lamp.

### BACKGROUND OF THE INVENTION

1. Field of the Invention

The present invention relates to an emergency lamp and, more particularly, to an emergency lamp using the optical energy.

2. Description of the Related Art

A conventional emergency lamp comprises a housing, a lamp shade combined with the housing, and a light mounted in the housing to emit light beams outwardly from the lamp shade. Thus, when the normal electric power is shut due to an irregular condition, such as happening of an electric power malfunction, an earthquake or a fire, the emergency lamp is operated to open the light which emits light beams outwardly from the lamp shade so as to provide an emergency illuminating function. However, the electric power of the emergency lamp is supplied by a mains power supply, and the light needs a larger electric power, thereby wasting the energy.

### BRIEF SUMMARY OF THE INVENTION

In accordance with the present invention, there is provided an emergency lamp, comprising a base, a lamp shade combined with the base, a control circuit mounted in the base, at least one storage battery mounted in the base, a light gathering board mounted in the lamp shade, a plurality of light emitting members mounted on the light gathering board, a light permeable board mounted on the lamp shade, and an optical energy board mounted on the lamp shade.

The primary objective of the present invention is to provide an emergency lamp having an energy-saving effect.

Another objective of the present invention is to provide an emergency lamp, wherein the electric power of the emergency lamp is supplied by the optical energy board without needing an external electric power supply, so that the emergency lamp has an energy-saving effect.

A further objective of the present invention is to provide an emergency lamp, wherein the lamp shade is provided with a direction indication portion to indicate the emergency escape direction.

A further objective of the present invention is to provide an emergency lamp, wherein the emergency lamp has energy-saving, emergency illuminating and emergency direction indicating functions, thereby enhancing the versatility of the emergency lamp.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of an emergency lamp in accordance with the preferred embodiment of the present invention.

FIG. 2 is a side cross-sectional assembly view of the emergency lamp as shown in FIG. 1.

FIG. 3 is a circuit diagram of a control circuit of the emergency lamp as shown in FIG. 1.

FIG. 4 is an exploded perspective view of an emergency lamp in accordance with another preferred embodiment of the present invention.

FIG. 5 is a perspective view of an emergency lamp in accordance with another preferred embodiment of the present invention.

### DETAILED DESCRIPTION OF THE INVENTION

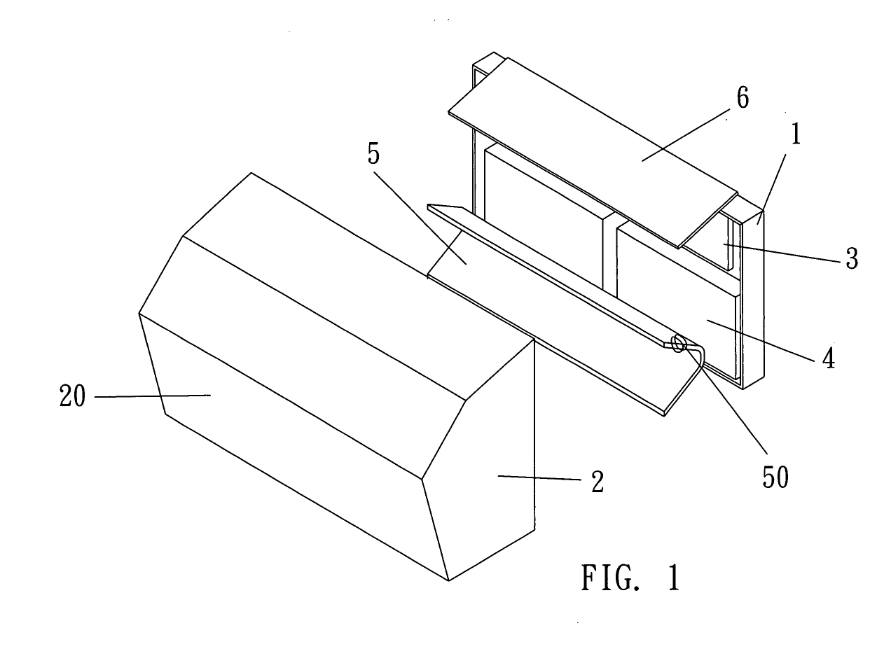

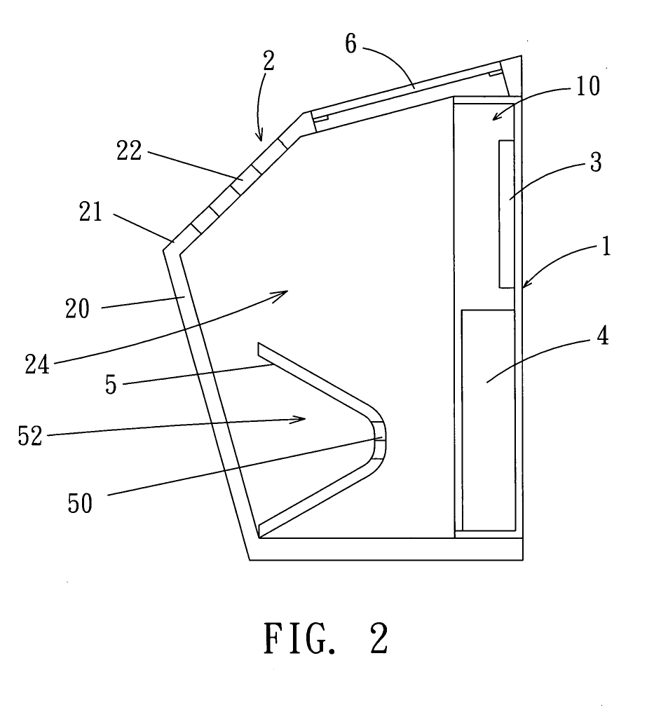

Referring to the drawings and initially to FIGS. 1-3, an emergency lamp in accordance with the preferred embodiment of the present invention comprises a base 1, a lamp shade 2 combined with the base 1, a control circuit 3 mounted in the base 1, at least one storage battery 4 mounted in the base 1, a light gathering board 5 mounted in the lamp shade 2, a plurality of light emitting members 50 mounted on the light gathering board 5, a light permeable board 20 mounted on the lamp shade 2, and an optical energy board 6 mounted on the lamp shade 2.

The base 1 has a hollow inside 10 for mounting the control circuit 3 and the storage battery 4.

The lamp shade 2 is combined with the base 1 integrally and has a hollow inside 24 for mounting the light gathering board 5.

The optical energy board 6 is mounted on a top face of the lamp shade 2 and located above the light gathering board 5.

The light permeable board 20 is mounted on a front side of the lamp shade 2 and located in front of the light gathering board 5. The light permeable board 20 is disposed at an inclined state.

The light gathering board 5 has a substantially V-shaped cross-sectional profile and has an opening 52 directed toward the light permeable board 20.

The light emitting members 50 are located at a central portion of the light gathering board 5. Each of the light emitting members 50 is made of a light emitting diode (LED).

The control circuit 3 is electrically connected to the optical energy board 6, the storage battery 4 and the light emitting members 50.

In operation, the solar energy collected by the optical energy board 6 is supplied into the control circuit 3 which converts the solar energy into an electric power which is supplied into the light emitting members 50 which emit light beams outwardly. At this time, the electric power is also stored in the storage battery 4. Then, the light beams emitted from the light emitting members 50 are gathered by the light gathering board 5, and the gathered light beams from the light gathering board 5 are emitted outwardly from the light permeable board 20 to provide an emergency illuminating effect. Thus, the electric power of the emergency lamp is supplied by the optical energy board 6, and each of the light emitting members 50 is made of a light emitting diode (LED), so that the emergency lamp has an energy-saving effect.

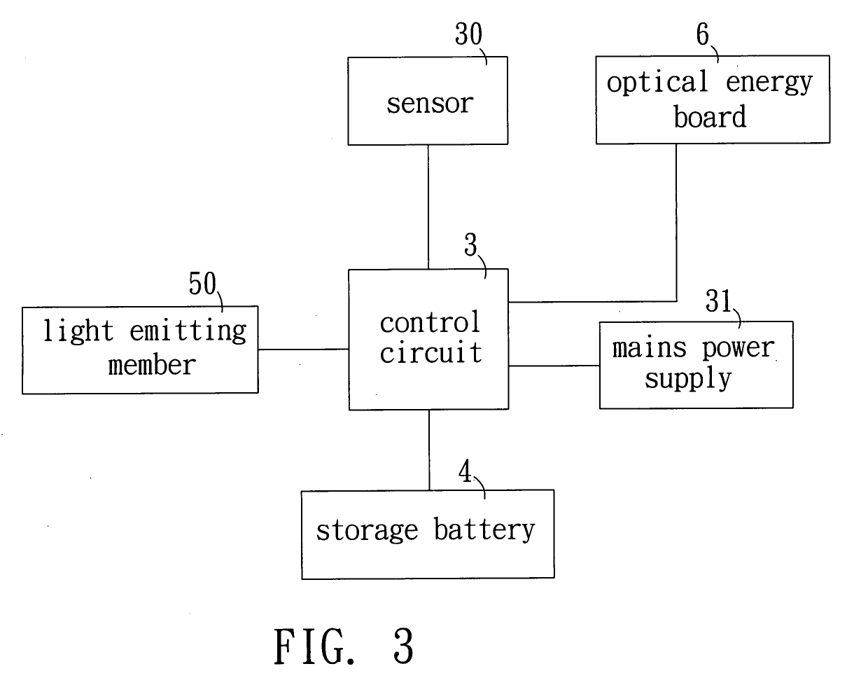

As shown in FIG. 3, the control circuit 3 is also electrically connected to a sensor 30. Preferably, the sensor 30 is a light source sensor which functions as a switch to control operation of the light emitting members 50 by detecting variation of an environmental lightness of the place in which the emergency lamp is disposed. For example, when the sensor 30 detects that the environmental lightness is smaller than a preset value, the control circuit 3 is operated to open the light emitting members 50 to provide an emergency illuminating effect, and when the sensor 30 detects that the environmental lightness is greater than a preset value, the control circuit 3 is operated to extinguish the light emitting members 50 so as to save the energy efficiently. Alternatively, the sensor 30 is a detection sensor (such as smoke detector, temperature detector or vibration detector) which functions as a switch to control operation of the light emitting members 50 by detecting variation of an environmental condition (such as smoke, temperature or vibration) of the place in which the emergency lamp is disposed.

As shown in FIG. 3, the control circuit 3 is also electrically connected to a mains power supply 31 to co-operate with the optical energy board 6 when the emergency lamp is disposed in a place whose environmental lightness is very weak.

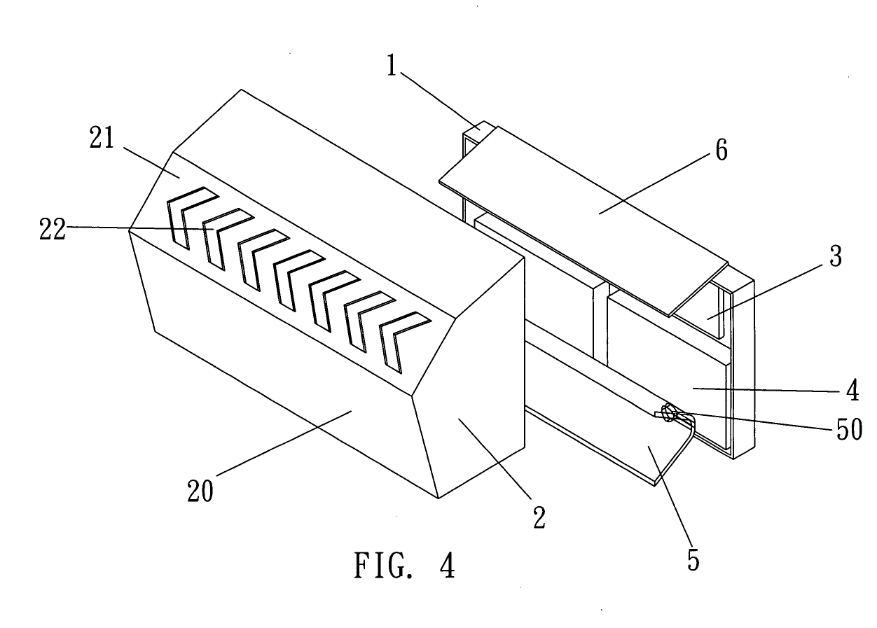

Referring to FIG. 4, the lamp shade 2 has a front end formed with an inclined face 21 provided with a light permeable direction indication portion 22 located between the light permeable board 20 and the optical energy board 6 to indicate the emergency escape direction. Preferably, the direction indication portion 22 includes a plurality of V-shaped marks arranged successively.

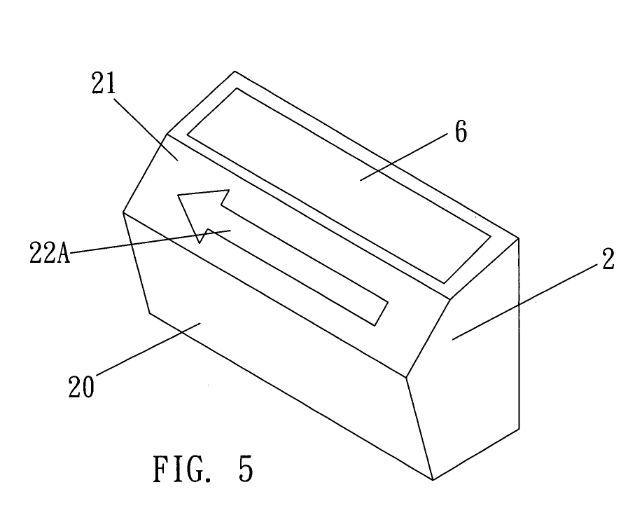

Referring to FIG. 5, the direction indication portion 22A includes a single arrow.

Accordingly, the electric power of the emergency lamp is supplied by the optical energy board 6 without needing an external electric power supply, so that the emergency lamp has an energy-saving effect. In addition, the lamp shade 2 is provided with a direction indication portion 22 to indicate the emergency escape direction. Further, the emergency lamp has energy-saving, emergency illuminating and emergency direction indicating functions, thereby enhancing the versatility of the emergency lamp.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An emergency lamp, comprising:
a base;
a lamp shade combined with the base;
a control circuit mounted in the base;
at least one storage battery mounted in the base;
a light gathering board mounted in the lamp shade;
a plurality of light emitting members mounted on the light gathering board;
a light permeable board mounted on the lamp shade;
an optical energy board mounted on the lamp shade.

2. The emergency lamp in accordance with claim 1, wherein the base has a hollow inside for mounting the control circuit and the storage battery.

3. The emergency lamp in accordance with claim 1, wherein the lamp shade has a hollow inside for mounting the light gathering board.

4. The emergency lamp in accordance with claim 1, wherein the optical energy board is mounted on a top face of the lamp shade.

5. The emergency lamp in accordance with claim 1, wherein the optical energy board is located above the light gathering board.

6. The emergency lamp in accordance with claim 1, wherein the light permeable board is mounted on a front side of the lamp shade and located in front of the light gathering board.

7. The emergency lamp in accordance with claim 1, wherein the light permeable board is disposed at an inclined state.

8. The emergency lamp in accordance with claim 1, wherein the control circuit is electrically connected to the optical energy board, the storage battery and the light emitting members.

9. The emergency lamp in accordance with claim 1, wherein the a solar energy collected by the optical energy board is supplied into the control circuit which converts the solar energy into an electric power which is supplied into the light emitting members which emit light beams outwardly.

10. The emergency lamp in accordance with claim 9, wherein the electric power is also stored in the storage battery.

11. The emergency lamp in accordance with claim 9, wherein the light beams emitted from the light emitting members are gathered by the light gathering board, and the gathered light beams from the light gathering board are emitted outwardly from the light permeable board to provide an emergency illuminating effect.

12. The emergency lamp in accordance with claim 9, wherein the electric power of the emergency lamp is supplied by the optical energy board.

13. The emergency lamp in accordance with claim 1, wherein each of the light emitting members is made of a light emitting diode (LED).

14. The emergency lamp in accordance with claim 1, wherein the control circuit is also electrically connected to a sensor.

15. The emergency lamp in accordance with claim 14, wherein the sensor is a light source sensor which functions as a switch to control operation of the light emitting members by detecting variation of an environmental lightness of a place in which the emergency lamp is disposed.

16. The emergency lamp in accordance with claim 14, wherein the sensor is a detection sensor which functions as a switch to control operation of the light emitting members by detecting variation of an environmental condition of a place in which the emergency lamp is disposed.

17. The emergency lamp in accordance with claim 1, wherein the control circuit is also electrically connected to a mains power supply to co-operate with the optical energy board.

18. The emergency lamp in accordance with claim 1, wherein the lamp shade has a front end formed with an inclined face provided with a light permeable direction indication portion.

19. The emergency lamp in accordance with claim 1, wherein the direction indication portion is located between the light permeable board and the optical energy board.

20. The emergency lamp in accordance with claim 1, wherein the light gathering board has a substantially V-shaped cross-sectional profile and has an opening directed toward the light permeable board, and the light emitting members are located at a central portion of the light gathering board.
